(19) United States
(12) Patent Application Publication
(10) Pub. No.: US 2017/0300985 A1
(43) Pub. Date: Oct. 19, 2017

(54) INFORMATION PROCESSING DEVICE, INFORMATION PROCESSING METHOD, AND INFORMATION PROCESSING PROGRAM

(71) Applicant: Rakuten, Inc., Tokyo (JP)

(72) Inventor: Isao TAKAHASHI, Tokyo (JP)

(73) Assignee: Rakuten, Inc., Tokyo (JP)

(21) Appl. No.: 15/515,898

(22) PCT Filed: Nov. 24, 2015
(86) PCT No.: PCT/JP2015/082951

§ 371 Date: Mar. 30, 2017

(51) Int. Cl. G06Q 30/06

(52) U.S. Cl. CPC G06Q 30/0601

(57) ABSTRACT

The system controller identifies, for each candidate user, a target item to be sold by a target seller and a comparison item to be sold by another seller than the target seller. The system controller then compares, for each candidate user, transaction terms between the above identified target and comparison items. The system controller changes the transaction terms of the target item so that they become more favorable than or comparable to the transaction terms of the comparison item. The system controller determines, with priority given to candidate users for which a value corresponding to the difference between pre-change transaction terms and post-change transaction terms of the target item is relatively small, a plurality of target users to be notified of the post-change transaction terms.

### TECHNICAL FIELD

The present invention relates to techniques, including systems, for changing the transaction terms of an item, for example, based on a user's viewing history for the item.

### BACKGROUND ART

Techniques for providing information about an item that matches interests of a user to be provided with an advertisement, from among items registered to be advertised by a store, are conventionally known. For example, Patent Literature 1 discloses a technique for determining that a superordinate concept of a keyword in page information that a requester has requested to view is a personality of the requester and for sending the requested page information with advertisement information that matches the personality to the requester. Patent Literature 2 discloses a technique for displaying, to a user browsing a biog site that is different from an auction site, information about an item that the user added to his or her watch list, in a banner on the blog site.

### CITATION LIST

### Patent Literature

Patent Literature 1: JP 2012-138046 A

Patent Literature 2: JP 2014-157560 A

### SUMMARY OF INVENTION

### Technical Problem

In some cases, when a plurality of sellers are competing with each other for an item, each seller may change the transaction terms of the item that the seller sells, so as to be more competitive than the other sellers, for example, by reducing the selling price of the item. However, it is desirable that such a change in transaction terms imposes as light a burden (financial resource burden) on a seller as possible. With the conventional techniques, it is difficult to determine users on which a change with less burden on a seller can produce a relatively high sales promotion effect.

Therefore, in view of the above, it is an object of the present invention to provide an information processing device, an information processing method, and an information processing program that are capable of determining users on which a change with less burden on a seller can produce a relatively high sales promotion effect to be notified of post-change transaction terms of a target item.

### Solution to Problem

To solve the above problem, the invention according to claim 1 includes item identifying means, terms chancing means, and user determination means. Storage means stores, for each user, the user's operation history for items. From the storage means, the item identifying means identifies, for each user, a target item to be provided by a specific seller and a comparison item to be sold by another seller than the specific seller and to be compared with the target item, among a plurality of items indicated by the user's operation history. The terms changing means compares, for each of the users, the transaction terms of the target item with the transaction terms of the comparison item. The terms changing means changes, for each of the users, the transaction terms of the target item so that the transaction terms of the target item become more favorable than or comparable to the transaction terms of the comparison item if the transaction terms of the comparison item are more favorable than the transaction terms of the target item. From among the users corresponding one-to-one to the target items whose transaction terms have been changed, the user determination means determines, with priority given to users for which a value corresponding to the difference between the transaction terms of the target item before chance and the transaction terms of the target item after change is relatively small, a plurality of users to be notified of the transaction terms after the change, so as to satisfy the specific seller's seller requirements.

This invention makes it possible to determine users on which a change with less burden on a seller can produce a relatively high sales promotion effect to be notified of post-change transaction terms of a target item.

The invention according to claim 2 is the information processing device according to claim 1 in which the user determination means determines, with priority given to users for which the value is relatively small and whose purchase expectation for the target item is relatively high, a plurality of users to be notified of the transaction terms after the change, so as to satisfy the specific seller's seller requirements.

This invention makes it possible to determine users who are likely to purchase a target item and on which a change with less burden on a seller can produce a relatively high sales promotion effect to be notified of post-change transaction terms of the target item.

The invention according to claim 3 is the information processing device according to claim 1 or 2 further including acceptable amount determination means. The acceptable amount determination means counts the number of users paying attention to the target item, based on users' operation histories for the target item. The acceptable amount determination means determines an acceptable amount relative to the number of users paying attention. The acceptable amount is acceptable for change in the transaction terms of the target item. The terms changing means changes, for each of the users, the transaction terms of the target item so that the value corresponding to the difference between the transaction terms of the target item before change and the transaction terms of the target item after change becomes less than or equal to the acceptable amount determined by the acceptable amount determination means.

This invention can facilitate the sale of a target item.

The invention according to claim 4 is the information processing device according to claim 3 in which the acceptable amount determination means calculates the number of people required to sell out the remaining stock of the target item, based on the conversion rate of items to be provided by the specific seller and on the stock quantity of the target item. The smaller number of users paying attention is less than the required number of people, the larger acceptable amount the accept able amount determination means determines.

This invention can reduce the unsold remainder of a target item.

The invention according to claim 5 is the information processing device a cording to claim 1 or 2 further including acceptable amount determination means. The acceptable amount determination means determines an acceptable amount based on a corresponding user's purchase expectation for the target item. The acceptable amount is acceptable for change in the transaction terms of the target item. The terms changing means changes, for each of the users, the transaction terms of the target item so that the value corresponding to the difference between the transaction terms of the target item before change and the transaction terms of the target item after change becomes less than or equal to the acceptable amount determined by the acceptable amount determination means.

This invention can facilitate the sale of a target item.

The invention according to claim 6 is the information processing device according to any one of claims 1 to 5 in which

the terms changing means selects, for each of one or more of the users, a change that contributed to purchases of items by the user, from among a plurality of types of changes, based on actual purchases indicated by the user's purchase history, and changes the transaction terms of the target item, based on the determined change.

This intention enables selection of a change that can satisfy a user's wishes and that has a high sales promotion effect.

The invention according to claim 7 is the information processing device according to any one of claims 1 to 6 in which

the terms changing means identifies, for each of one or more of the users, a transaction element included in the transaction terms of the target item but not included in the transaction terms of the comparison item as a target element, determines a change to delete the identified target element, and changes the transaction terms of the target item, based on the determined change.

This invention can reduce a financial resource burden imposed on a seller and facilitate the sale of a target item.

The invention according to claim 8 is the information processing device according to any one of claims 1 to 7 in which the terms changing means identifies, for each of one or more of the users, a transaction element included in the transaction terms of the comparison item but not included in the transaction terms of the target item as a target element, determines a change to add the identified target element, and changes the transaction terms of the target item, based on the determined change.

This invention can facilitate the sale of a target item.

The invention according to claim 9 is the information processing device according to claim 7 or 8 in which the item identifying means identifies, for each of one or more of the users, a target item to be provided by a specific seller, a comparison item to be sold by another seller than the specific seller and to be compared with the target item, and other items except the target and comparison item, among a plurality of items indicated by the user's operation history. Based on transaction elements included in transaction terms of the other items, the terms changing means identifies the target element.

This intention enables a transaction element that can satisfy a user's wishes to be identified.

The invention according to claim 10 is an information processing method performed by a computer. The method includes the following steps. Storage means stores, for each user, the user's operation history for items. From the storage means, a target item to be provided by a specific seller and a comparison item to be sold by another seller than the specific seller and to be compared with the target item are identified for each user, among a plurality of items indicated by the user's operation history. The transaction terms of the target item are compared, for each of the users, with the transaction terms of the comparison item. The transaction terms of the target item are changed, for each of the users, so as to become more favorable than or comparable to the transaction terms of the comparison item if the transaction terms of the comparison item are more favorable than the transaction terms of the target item. With priority given to users for which a value corresponding to a difference between the transaction terms of the target item before change and the transaction terms of the target item after change is relatively small, a plurality of users to be notified of the transaction terms after the change are determined so that the specific seller's seller requirements are satisfied, from among the users corresponding one-to-one to the target items whose transaction terms have been changed.

The invention according to claim 11 causes a computer to function as item identifying means, terms changing means, and user determination means. Storage means stores, for each user, the user's operation history for items. From the storage means, the item identifying means identifies, for each user, a target item to be provided by a specific seller and a comparison item to be sold by another seller than the specific seller and to be compared with the target item, among a plurality of items indicated by the user's operation history. The terms changing means compares, for each of the users, the transaction terms of the target item with the transaction terms of the comparison item. The terms changing means changes, for each of the users, the transaction terms of the target item so that the transaction terms of the target item become more favorable than or comparable to the transaction terms of the comparison item if the transaction terms of the comparison item are more favorable than the transaction terms of the target item. From among the users corresponding one-to-one to the target items whose transaction terms have been changed, the user determination means determines, with priority given to users for which a value corresponding to the difference between the transaction terms of the target item before change and the transaction terms of the target item after change is relatively small, a plurality of users to be notified of the transaction terms after the change, so as to satisfy the specific seller's seller requirements.

### Advantageous Effects of Invention

This invention makes it possible to determine users on which a change with less burden on a seller can produce a relatively high sale promotion effect to be notified of post-change transaction terms of a target item.

### BRIEF DESCRIPTION OF DRAWINGS

FIG. 1 is a diagram schematically showing an example configuration of an information providing system S according to this embodiment.

FIG. 2A is a block diagram schematically showing an example configuration of an information providing server SA according to this embodiment.

FIG. 2B is a diagram showing example functional blocks in a system controller 4.

FIG. 3A is a diagram showing an example of typical changes in the transaction terms of an item.

FIG. 3B a diagram showing an example of information in a total information database 25.

FIGS. 4A to 4D are each a diagram showing an example comparative table associating the attribute values of transaction elements of a target item with the attribute values of transaction elements of a comparison item.

FIG. 5A is a diagram showing, for each candidate user Un, an example relationship between a value corresponding to the difference between pre-change transaction terms and post-change transaction terms of a target item and a priority for determining the candidate user Un to be a target user Un.

FIG. 5B is a diagram showing, for each candidate user Un, an example relationship among a value corresponding to the difference between pre-change transaction terms and post-change transaction terms of a target item, an purchase expectation of the candidate user Un, and a priority for determining the candidate user Un to be a target user Un.

FIG. 6 is a flowchart showing an example of an information provision process performed by the system controller 4 of the information providing server SA.

FIG. 7 is a diagram showing an example screen displaying notification information on a web page being displayed in a window of a web browser of a user terminal UTn maintaining a session.

### DESCRIPTION OF EMBODIMENTS

The following describes an embodiment of the present invention with reference to the drawings. In the embodiment described below, the present invention is applied to an information providing system.

### 1. Configuration and Functional Overview of Information Providing System

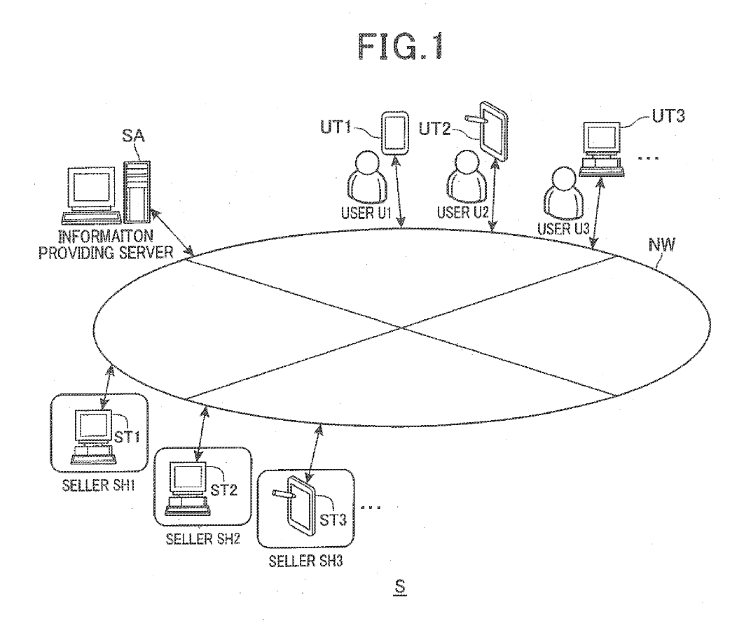

A configuration and a functional overview of an information providing system S according to this embodiment is first described with reference to FIG. 1 and other figures. FIG. 1 is a diagram schematically showing an example configuration of the information providing system S according to this embodiment. As shown in FIG. 1, the information providing system S includes, for example, a plurality of seller terminals STm (m=1, 2, 3 . . . ), a plurality of user terminals UTn (n=1, 2, 3. . . ), and an information providing server SA. The seller terminals STm, the user terminals UTn, and the information providing server SA are each connected to a network NW. The network NW includes, for example, the Internet, a dedicated communication line (e.g., community antenna television (CATV) line), a mobile communication network (including base stations), and a gateway.

Each seller terminal STm is a terminal device used by a seller SHm (m=1, 2, 3 . . . ) that sells (provides) items. The seller SHm is a providing entity that sells items through the information providing system S. This embodiment is described by taking stores (also including various types of facilities) run by individuals, corporations, or groups as examples of the seller SHm. Items in this embodiment mean items to be transacted. Examples of categories of such items (item categories) include, but are not limited to, home appliances (e.g., televisions, audio equipment, personal computers, and cameras), food, fashion, interiors, books, sundries, cars, digital content, and tickets. For example, the items include not only accommodation plans or travel plans to be sold by facilities or travel agencies but also usage plans to be sold by gold facilities, accommodation facilities, or the like. Each user terminal UTn is a terminal device used by a user. Un (n=1, 2, 3 . . . ) who considers purchasing items (or purchases items).

The seller terminals STm and the user terminals UTn each include, for example, an input/display unit, a communication unit, a storage unit, and a controller. The input/display unit includes a touch screen having an input function and a display function. The input function receives operations (user operations) performed with someone's finger, a pen, or the like. The display function displays information on a display screen. There are some types of user operations, such as search operations, viewing operations, bookmark operations, and add-to-cart operations. The communication unit is responsible for connecting to the network NW and for controlling the state of communications. The storage unit stores an operating system (OS), application programs, a web browser program, and other programs. The controller includes, for exam e a central processing unit (CPU), a read only memory (ROM), and a random access memory (RAM). The controller executes the application programs, the web browser program, and other programs on the OS. For example, a personal computer (PC), a mobile phone, a personal digital assistant (PDA), a mobile terminal (smartphone) that is a mobile phone integrated with a personal digital assistant, or a mobile gaming device can be used as a seller terminal STm and a terminal UTn. Each of the seller terminals STm and the user terminals UTn is capable of accessing and communicating with the information providing server SA via its communication unit and the network NW. Each of the seller terminals STm and the user terminals UTn displays, in a window of its web browser, for example, a web page that is sent from the information providing server SA in response to a request to the information providing server SA.

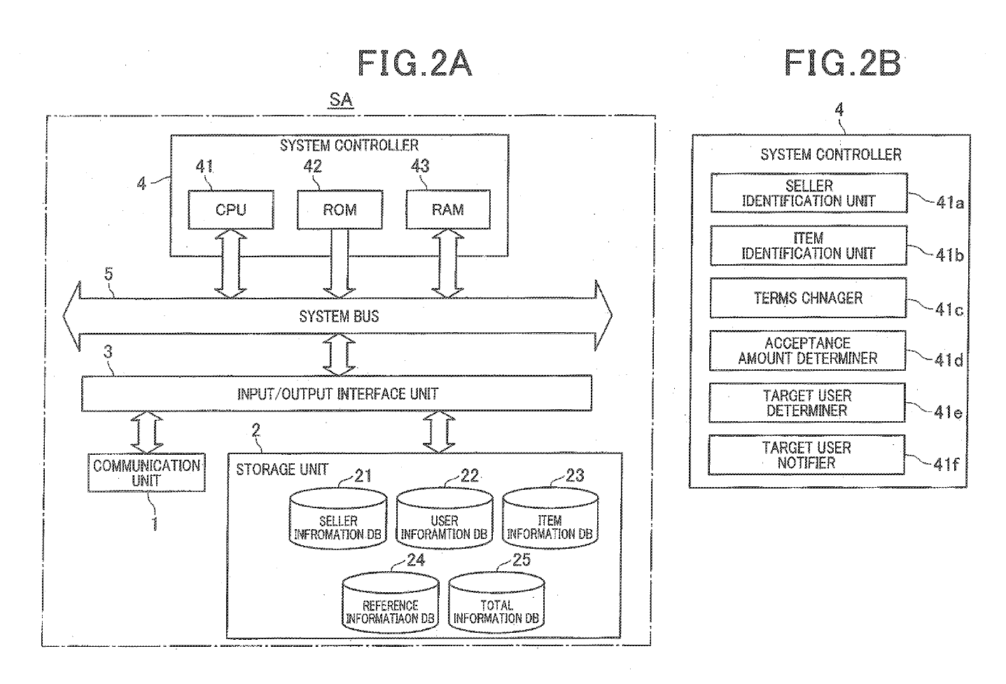

The information providing server SA is an example of an information processing device according to the present invention. The information providing server SA is a server that provides websites, such as a shopping site, an auction site, a travel reservation site, a lodging reservation site, and a facility reservation site. FIG. 2A is a block diagram schematically showing an example configuration of the information providing server SA according to this embodiment. As shown in FIG. 2A, the information providing server SA includes, for example, a communication unit 1, a storage unit 2 (an example of storage means), an input/output interface unit 3, and a system controller 4. The system controller 4 and the input/output interface unit 3 are connected via a system bus 5. The communication unit 1 is responsible for connecting to the network NW and for controlling the state of communications. The storage unit 2 includes, for example, hard disk drives. The storage unit 2 stores, for example, an operating system (OS) and server programs (including an information processing program according to the present invention). The server programs are downloaded from a predetermined server to the information providing server SA. Alternatively, the server programs may be stored in a (computer-readable) recording medium, such as a CD or a DVD, and be read from the recording medium into the storage unit 2. The storage unit 2 also stores, for example, electronic data that constitutes web pages. The storage unit 2 further has a seller information database (DB) 21, a user information database (DB) 22, an item information database (DB) 23, a reference information database (DB) 24, a total information database (DB) 25, and other databases, which were created therein.

The seller information database 21 is a database that stores information about sellers SHm that became members to use the information providing system S. For example, the seller information database 21 stores, for each seller SHm, the seller SHm's seller ID, password, seller name, and seller item information in association with each other. Each seller ID is identification information unique to the corresponding seller SHm. The seller ID and the corresponding password are authentication information required for the seller SHm to log in to the system. The seller item information includes, for example, the item ID of an item available for sale by the seller SHm, the common item code of the item, the name of the item, a sales promotion budget for the item, attribute information (e.g., the selling price and the specifications) of the item, the stock quantity of the item, a sales target (a target amount and a target quantity) for the item, and the actual sales (the sales amount and the sales quantity) of the item. Each item ID is, for example, item identification information unique to items with the same specifications (of the same model) by corresponding seller SHm and is a unique code in the system S. Items that have the same specifications but are sold by different seller SHm are assigned different item IDs. For example, even compact cameras (model C-123) that were manufactured by a maker and have the same specifications are assigned different item IDs if the items are sold by different sellers SHm. The items are also individually and variously priced by the sellers SHm.

Each common item code is a code unique to the corresponding item (e.g. the model of the item or an item number unique to the model) and common to a plurality of sellers SHm (a code used across the sellers). For example, in a case where items (e.g., home appliances) manufactured by a maker are sold by a store (i.e., in a case where the manufacturing entity of items is not the same as the selling entity of the items), the same common item code is assigned to items with the same specifications and maker price (list price) On the other hand, in a case where items (e.g., accommodation plans) produced by a stored such as an accommodation facility are sold by the store (i.e., in a case where the producing entity of items is the same as the selling entity of the items), a common item code may not be assigned to the items.

The sales promotion budget (an example budget) for the item is a financial resource for a contribution to be contributed based on how the transaction terms of the item change (e.g., a reduction in the selling price). The sales promotion budget is freely determined by the seller SHm and depends on the size (e.g., capital) of the seller SHm. The attribute information of the item is divided into a plurality of types of attribute elements and includes the attribute value of each attribute element. Different item categories may have different types of attribute elements. For example, in attribute information of a compact camera, an attribute value is set for each attribute element, such as “selling price”, “pixel count”, “zoom factor”, “size”, “weight”, “option”, and “points”. “Pixel count”, “zoom factor”, “size”, and “weight” are item specifications. Examples of this option include a camera case, a camera strap, and a memory card. Each of their attribute values indicates the amount (value) of the corresponding option. Points are a privilege given, as a reward for purchase of the item by a user Un, to the user Un, and their attribute value, indicates the number of points (e.g., 10 points). The user Un can use the points when paying for items. In attribute information of an accommodation plan, an attribute value is set for each attribute element, such as “selling price”, “meals”, “bath”, “option”, and “points”. Examples of this option include all-you-can-drink specific drinks, all-you-can-eat specific food (e.g., crab), and massage. Each of their attribute values indicates the amount of the corresponding option. Among the attribute elements, “selling price”, “option”, and “points” are example transaction elements that are used as changeable transaction terms of an item.

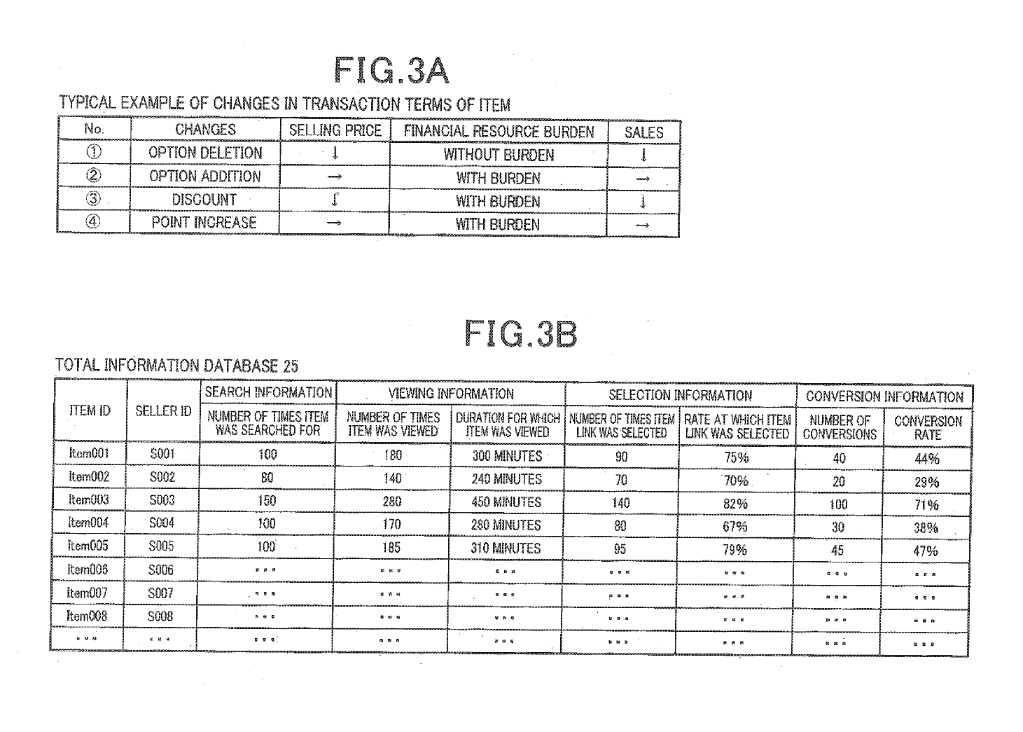

FIG. 3A is a diagram showing an example of typical changes in the transaction terms of an item. In the example of FIG. 3A, option deletion, option addition, discount (reduction in selling price), and point increase are shown as typical changes. The option deletion (option removal) involves a discount relative to the amount of an option to be deleted. Accordingly, the sales is expected to be down. However, none is contributed from the sales promotion budget, which does not impose any financial resource burden on a seller SHm. The option addition keeps the selling price, and the sales is expected to remain unchanged. However, the amount of an option to be added is contributed from the sales promotion budget. Accordingly, a financial resource burden is imposed on the seller SHm. The discount (price reduction) reduces the selling price. Correspondingly, the sales is expected to be down. In addition, the amount (value) of the reduction is contributed from the sales promotion budget. Accordingly, a financial resource burden is imposed on the seller SHm. The point increase keeps the selling price, and the sales is expected to remain unchanged. However, the amount (value) corresponding to the number of points to be increased is contributed from the sales promotion budget. Accordingly, a financial resource burden is imposed on the seller SHm. In some cases, priorities are assigned to the above changes depending on the seller SHm's purpose, whether the seller SHm places priority on increasing sales (hereinafter, referred to as “sales-oriented”) or places priority on reducing financial resource burdens (hereinafter, referred to as “financial resource burden-oriented”). For example, for a sales-oriented purpose, higher priorities are assigned to the above option addition and point increase than to the above option deletion and discount. For example, for a financial resource burden-oriented purpose, the highest priority is assigned to the option deletion, and higher priorities are assigned to the above option addition and point increase than to the above discount. These priorities, which are assigned to the changes depending on the seller SHm's purpose, may be stored in association with its seller ID in the seller information database 21.

The seller item information is stored, for example, in response to a storage request from the seller terminal STm that has accessed the information providing server SA. The stock quantity of the item and the actual sales of the item that are included in the seller item information are updated, for example, every time the transaction of the item is closed (i.e., the sales of the item is completed) or at predetermined intervals. When one seller SHm sells different types of items with different item specifications, seller item information about the different types of items is stored in the seller information database 21.

The user information database 22 is a database that stores information about users Un who became members to use the information providing system S. For example, the user information database 22 stores, for each user Un who became a member, the user Un's user ID, password, gender, age, email address, bookmark list, cart list, search history, viewing history, registration history, and purchase history in association with each other. Entries in the bookmark list (the registration history), entries in the cart list, the search history, the viewing history, and the purchase history are each an example of the user Un's operation (action) history for items. Each user Un's search history, viewing history, and purchase history may be stored in association with the user's user ID in a history information database that is provided separately from the user information database 22. Each user ID is user identification information unique to the corresponding user Un. The user ID and the corresponding password are authentication information required for the user Un to log in to the system.

The bookmark list is a list for registering items selected in accordance with bookmark operations performed by the user Un (the list is sometimes referred to as a favorites list). The items selected in accordance with the bookmark operations performed by the user Un can be said to be items that the user Un wishes to refer to later as items that the user Un became concerned with (or interested in). That is, the items added to the bookmark list (hereinafter, referred to as “bookmarked”) are items registered for future reference. The bookmark list includes, for example, a bookmark time, the item ID of an item selected in accordance with a bookmark operation, the common item code of the item, the seller ID and seller name of a seller SHm that sells the item, an item category to which the item belongs, the name of the item, attribute information of the item, and other information in association with each other. The bookmark time is, for example, the time at which the information providing server SA received a request (including the item ID of the item and other information) to bookmark the item selected in accordance with the bookmark operation or the time at which the item to be bookmarked was added to the bookmark list. The bookmark time may be expressed as a date and time, as a month, date, and time, or as a year, month, date, and time. The same applies to an add-to-cart time, a search time, a viewing time, and a purchase time, which will be described later. Examples of the bookmark operation include selecting (e.g., with a mouse click or by a finger tap or the like) a bookmark button provided on a screen displaying item information (e.g., a screen of a web page or an application). Bookmarking means storing item information in a memory area that stores the bookmark list. The bookmarking can be canceled in accordance with a bookmark cancel operation performed by the user. Examples of the bookmark cancel operation include selecting an item deletion button provided on a screen displaying information about a bookmarked item. For example, when the information providing server SA receives a request to cancel the bookmark of an item selected in accordance with a bookmark cancel operation, information about the item, which is to be unbookmarked, is deleted from the bookmark list.

The cart list is a list for registering items selected in accordance with add-to-cart operations performed by the user Un (the list is sometimes referred to as a shopping cart list). The items selected in accordance with the add-to-cart operations performed by the user Un can be said to be items that the user Un wishes to refer to later as items that the user Un will purchase or is considering whether to purchase. That is, the items added to the cart list (hereinafter, referred to as “added to the cart”) can be said to be items registered for future reference. The cart list includes, for example, an add-to-cart time, the item ID of an item selected in accordance with an add-to-cart operation, the common item code of the item, the seller ID and seller name of a seller SHm that sells the item, an item category to which the item belongs, the name of the item, attribute information of the item, and other information in association with each other. The add-to-cart time is, for example, the time at which the information providing server SA received a request (including the item ID of the item and other information) to add, to the cart, the item selected in accordance with the add-to-cart operation or the time at which the item to be added to the cart was added to the cart list. Examples of the add-to-cart operation include selecting an add-to-cart button provided on a screen displaying information about an item. “Adding to the cart” means storing item information in a memory area that stores the cart list. The “adding to the cart” can be canceled in accordance with an add-to-cart cancel operation performed by the user. Examples of the add-to-cart cancel operation include selecting an item deletion button provided on a screen displaying information about an item added to the cart. For example, when the information providing server SA receives a request to cancel the addition, to the cart, of an item selected in accordance with an add-to-cart cancel operation, information about the item, which is to be deleted from the cart, is deleted from the cart list.

The search history includes, for example, a search time, a search query, a session ID, and search results in association with each other. The search time is, for example, the time at which the information providing server SA received a search request including the search query or the time at which the information providing server SA performed a search. The search query includes search terms (e.g., one or more parts of speech) as narrowing criteria. The search terms are specified in accordance with a search operation performed by the user Un. Examples of the search operation include selecting a search button after the above search terms are entered in a search term entry field provided on an item search screen (or after the above search terms are selected from a list of item categories). Each session ID is an identification code unique to corresponding one session. One session extends, for example, from when the web browser of the user terminal UTn accesses the information providing server SA until the web browser is closed (or an application is terminated). The search results include the item ID of each item found by a search based on, the search query, the common item code of the item, the seller name of a seller SHm that sells the item, an item category to which the item belongs, the name of the item, attribute information of the item, and other information in association with each other. The items found by the search based on the search query are items that satisfy the search query “camera & compact”, where ‘&’ is usually specified as “ ” (space)). This search history includes, for example, records each of which is distinguished from the others by a corresponding search request including a search query from the user terminal UTn. The number of these records is counted for each item ID to calculate the number of searches for each item ID. If no items were found by the search based on the search query, the resulting search results include information (NULL) indicating no hits

The viewing history includes a viewing time, a session ID, a viewing duration (length), the item ID of an item viewed in accordance with a viewing operation performed by the user Un, the common item code of the item, the seller ID and seller name of a seller SHm that sells the item, an item category to which the item belongs, the name of the item, attribute information of the item, and other information in association with each other. The viewing time is, for example, the time at which the information providing server SA received a request (including the item ID of the item and other information) to view detailed information about the item selected in accordance with the viewing operation or the time at which the information providing server SA sent the requested detailed information about the item to the user terminal UTn. Alternatively, the viewing time may be the time at which the requested detailed information about the item was displayed on a screen or the time at which a detailed item information display page displaying the detailed information about the item was displayed in a window of the web browser. Examples of the viewing operation include selecting an item link embedded within an item name, an item image, and the like on a screen (e.g., a search results display page) displaying search results retrieved based on a search query and selecting an item link embedded in a banner ad area provided on a web page. The item link (hyperlink) includes a uniform resource locator (URL) indicating where the detailed information about the item can be found. The viewing duration is, for example, from a display start time of the item (the above viewing time) to a corresponding display end time. The display end time is, for example, the time at which a screen transition (e.g., a page transition) was made or the time at which display of the screen ended. This viewing history includes, for example, records each of which is distinguished from the others by a corresponding viewing request from the user terminal UTn. The number of these records is counted for each item ID to calculate the number of views for each item ID. In particular, the number of records within a past predetermined period of time is counted for each item ID to calculate the number of views for each item ID.

The number of records including a viewing duration greater than or equal to a threshold value (e.g., 10 seconds) may be counted for each item ID to calculate the number of views for each item ID. The viewing history may include the type of the item link on which the viewing operation was performed. The type of the item link indicates either an item link embedded within an item name, an item image, and the like on a screen (e.g., a search results display page) displaying search results, or an item link embedded in a banner ad area. When the type of the item link indicates an item link embedded in a banner ad area, the viewing history includes an ID identifying an banner ad displayed in this banner ad area. The number of records of a viewing history in which the type of the item link indicates an item link embedded in a banner ad area is counted for each item ID to calculate the number of selections (which correspond to the number of clicks and the number of taps) for each item ID. A selection rate is calculated by dividing, for each item ID, the above number of selections by the number of impressions of the item link embedded in the banner ad area. The number of selections and the selection rate can be used to measure advertising effectiveness.

The purchase history includes a purchase time, a session ID, the item ID of a purchased item, the common item code of the item, the seller ID and seller name of a seller SHm that sells the item, an item category to which the item belongs, the name of the item, attribute information of the item, and other information in association with each other. The purchase time is, for example, the time at which the information providing server SA received a request (including the item ID of the item and other information) to purchase the item selected in accordance with a purchase operation or the time at which a payment process for the item to be purchased was completed. Examples of the purchase operation include selecting a purchase button provided on a screen (e.g., a purchase page) displaying information about item(s) added to the cart. This purchase history includes, for example, records each of which is distinguished from the others by a corresponding purchase request from the user terminal UTn. When a change in the transaction terms of an item resulted in purchase of the item, a purchase history for the item may include, for example, the change in the transaction terms (or a corresponding typical change shown in FIG. 3A) and the time at which the transaction terms were changed, in association with the item ID of the item. This allows evaluation of sales promotion effects based on the change in the transaction terms of the item. Alternatively, when selection of the item link embedded in the banner ad area resulted in purchase of the item (this is referred to as a conversion), the purchase history for the item includes a flag indicating the conversion. The number of records including a purchase history in which a flag indicating a conversion is included is counted for each item ID to calculate the number of conversions for each item ID. This number of conversions can be used to measure advertising effectiveness.

The item information database (item database) 23 is a database that stores information about items marketed as transaction objects by the sellers SHm, among the items indicated by the seller item information stored in the seller information database 21. For example, the item information database 23 stores, for each of the items marketed as transaction objects by the sellers SHm, the item ID of the item, the common item code of the item, an item category to which the item belongs, the name of the item, attribute information of the item, the stock quantity of the item (the stock quantity of the item in a seller SHm that marketed the item), and the seller ID and seller name of the seller SHm, and other information in association with each other. The item information database 23 may store transaction elements allowed for change (change in transaction terms) among the transaction elements of the item, and an acceptable amount that is acceptable for the change, in association with the item ID of the item. For example, \7,000 (initially set at \8,000) is stored as the acceptable amount that is acceptable for the change. The transaction elements allowed for change and the acceptable amount that is acceptable for the change are, for example, freely set by the seller SHm of the item.

The reference information database 24 is a database that stores reference information of items registered for future reference by the users Un. The reference information database 24 stores, for each user Un, reference information of an item registered for future reference by the user Un, a registration time of the item, and the user ID of the user Un in association with each other. The reference information includes, for example, the item ID of an item added to at least either the bookmark list or the cart list, the common item code of the item, the seller ID and seller name of a seller SHm that sells the item, an item category to which the item belongs, the name of the item, attribute information of the item, the stock quantity of the item, and other information in association with each other. Alternatively, the reference information may include only the item ID, because the common item code of the item, the seller ID and seller name of a seller SHm that sells the item, an item category to which the item belongs, the name of the item, attribute information of the item, and the stock quantity of the item can be retrieved using the item ID of the above item as a key, for example, from the item information database 23. The registration time of the item is the time at which the item was added to the bookmark list or the cart list. Every time an item is added to the bookmark list or the cart list, reference information of the item. and the registration time of the item are stored in the reference information database 24. Every time an item is removed from the bookmark list or the cart list, the reference information of the item and the registration time of the item are deleted from the reference information database 24. Alternatively, entries in the bookmark list and the cart list may be checked at predetermined intervals (e.g., 12 hours) and the result of the check may be reflected in the reference information database 24. Even for an item not added to either the bookmark list or the cart list, if the viewing duration or the number of views for the item, which are identified from a viewing history for items viewed in accordance with the user Un's viewing operations, satisfies a predetermined view condition, the item is (automatically) registered for future reference by the user Un corresponding to the viewing history. In this case, reference information of the item automatically registered, the registration time of the item, and the user ID of the user Un are stored in the reference information database 24.

The total information database 25 is a database that stores total information based on the users Un's operation histories for marketed items. The total information includes search information, viewing information, selection information, and conversion information. FIG. 3B is a diagram showing an example of information in the total information database 25. For example, as shown in FIG. 3B, the total information database 25 stores, for each item, search information, viewing information, selection information, conversion information, the item ID of the item, and the seller ID of a seller SHm that sells the item in association with each other. The search information includes the number of times that the item was searched for. The number of times that the item was searched for is calculated by totaling the numbers of searches identified from the search histories of the plurality of users Un. The viewing information includes the number of times that the item was viewed and the duration for which the item was viewed. The number of times that the item was viewed is calculated by totaling the numbers of views identified from the viewing histories of the plurality of users Un. The duration for which the item was viewed is calculated by totaling the viewing durations identified from the viewing histories of the plurality of users Un. The selection information includes the number of times (CT) that and the rate (CTR) at which the item link embedded in the banner ad area was selected (clicked). The number of times that the item was selected is calculated by totaling the numbers of selections identified from the viewing histories of the plurality of users Un. The rate at which the item link was selected is calculated by dividing, for each item ID, the above number of times that the item was selected by the number of impressions of the item link embedded in the banner ad area (the rate at which the item link was selected=the number of times that the item was selected/the number of impressions). The conversion information includes the number of conversions (CV) and the conversion rate (CVR) of the item. The number of conversions is calculated by totaling the numbers of conversions identified from the purchase histories of the plurality of users Un. The conversion rate is calculated by dividing, for each item ID, the above number of conversions by the above number of selections (the conversion rate=the number of conversions/the number of selections). Every time the item link embedded in the banner ad area is selected, the information providing server SA may count this to calculate the number of selections and also the selection rate, and then store them in the total information database 25. In addition, every time the item link embedded in the banner ad area is selected and converted, the information providing server SA may count this to calculate the number of conversions and also the conversion rate, and then store them in the total information database 25.

The system controller 4 as a computer includes, for example, a CPU 41 (processor), a ROM 42, and a RAM 43 (an example of storage means). The system controller 4 executes the server programs and other programs on the OS. FIG. 2B is a diagram showing example functional blocks in the system controller 4. As shown in FIG. 2B, the system controller 4 (the processor in the system controller 4) executes the server programs and other programs to function as, for example, a seller identification unit 41a, an item identification unit 41b, a terms changer 41c, an acceptable amount determiner 41d, a target user determiner 41e, and a target user notifier 41f. The item identification unit 41b is an example of item identifying means. The terms changer 41c is an example of terms changing means. The acceptable amount determiner 41d is an example of acceptable amount determination means. The target user determiner 41e is an example of user determination means.

The seller identification unit 41a obtains, for each seller SHm that sells marketed items, the element value of a counting element of the items, based on the users Un's operation histories for the marketed items. Examples of the counting element include the number of times that an item was viewed, the duration for which an item was viewed, the number of limes that an item link was selected, the rate at which an item link was selected, the number of conversions, and a conversion rate. Which counting element to use can be freely set. Tor example, the seller identification unit 41a retrieves, for each seller SHm (i.e., seller ID), the element value of a counting element set by a system administrator or the like from the total information database 25. For example, in the examples of FIG. 3B, if the counting element is the number of times that an item was selected, “90”, “70”, “140”, “80”, “95” are each retrieved. When the element values of a counting element of a plurality of items are stored in association with one seller ID in the total information database 25, for example, the average value (alternatively, the standard deviation value or the median value) of the element values of the counting element of the plurality of items is obtained as the element value of the counting element. The seller identification unit 41a identifies, as target sellers SHm (an example of specific sellers), sellers SHm that sell items corresponding to relatively small element values (e.g., items whose element value is a predetermined rank or less away from the smallest element value), among the element values retrieved for the sellers SHm. This enables the sellers SHm that sell less competitive items to be selected as promotion targets. The seller identification unit 41a may identify, as target sellers SHm, sellers SHm whose element value is relatively low compared with a predetermined criterion. Alternatively, the seller identification unit 41a may preferentially identify all sellers SHm having the above element value that does not meet the above criterion. The criterion (hurdles) for being identified as a target seller may be different for each seller SHm.

Subsequently, from among a plurality of items indicated by each user Un's (hereinafter, referred to as each “candidate user Un”) operation history for items to be sold by a target seller SHm identified by the seller identification unit 41a, the item identification unit 41b identifies, for each candidate user Un, a target item to be sold by the target seller SHm and a comparison item to be sold by another seller SHm than the target seller SHm and to be compared with the above target item. That is, a set of target and comparison items (hereinafter, referred to as an “item set”) is identified for each candidate user Un. In each item set, the item ID of the target item and the item ID of the comparison item are associated with the same user ID. If there are a plurality of items to be sold by the target seller SHm, for example, an item whose predetermined counting element (e.g. a counting element that the target seller SHm used for identification) has the smallest element value or an item having an element value of ten or less ranks away from the smallest is identified as a target item, among the plurality of items. Alternatively, in this case, for example, a plurality of items whose predetermined counting element (e.g. a counting element that the target seller SHm used for identification) has an element value less than or equal to a representative element value (the average value, standard deviation value, or median value of element values) as all of the plurality of sellers SHm may be identified as target items, among the plurality of items.

In each item set, the comparison item to be compared with the target item corresponds to a related item that is related to the target item. For example, the related item, which is related to the target item, is an item that belongs to the same item category as the target item and that includes part of the name of the target item (e.g., “compact camera”). Alternatively, the related item, which is related to the target item, may be an item preregistered (e.g., registered in accordance with a registration operation performed by the seller SHm that sells the target item) as an item competitive with the target item in a database. Alternatively, the related item, which is related to the target item, may be an item assigned the same common item code as the target item.

The comparison item to be compared with the target item may correspond to a related item that is related to the target item and that was viewed at approximately the same time as the target item. The fact that the related item was viewed at approximately the same time as the target item means that the difference between the time at which the target item was viewed and the time at which the related item was viewed is less than or equal to a threshold value (e.g., thirty minutes). Alternatively, the comparison item to be compared with the target item may correspond to a related item that is related to the target item and that was viewed with approximately the same frequency (or for approximately the same duration) as the target item. The fact that the related item was viewed with approximately the same frequency as the target item means that the difference between the frequency with which the target item was viewed and the frequency with which the related item was viewed is less than or equal to a threshold value (e.g., three times). The fact that the related item was viewed for approximately the same duration as the target item means that the difference between the duration for which the target item was viewed and the duration for which the related item was viewed is less than or equal to a threshold value (e.g., ten minutes).

If there are a plurality of items (e.g., related items) that correspond to comparison items, an item that has the most favorable transaction terms of these items is identified as a comparison item. Examples of the item that has the most favorable transaction terms include an item whose transaction terms include the lowest selling price. If there are a plurality of items whose transaction terms include the lowest selling price, the item that has the most favorable transaction terms corresponds to, for example, an item whose transaction terms include an option. Also, if there are a plurality of items whose transaction terms include the lowest selling price and an option, the item that has the most favorable transaction terms corresponds to an item whose transaction terms include the highest amount of option (if there are a plurality of options, the total amount of the options). Moreover, if there are a plurality of such items, the item that has the most favorable transaction terms corresponds to an item whose transaction terms include the largest number of points. If there are a plurality of items whose transaction terms include the lowest selling price, the item that has the most favorable transaction terms may correspond to, for example, an item whose transaction terms include the largest number of points. Alternatively, if there are a plurality of items whose transaction terms include the lowest selling price, the item that has the most favorable transaction terms may correspond to, for example, an item with the highest sum total of the amount relative to the number of points included in its transaction terms and the amount of an option.

It is desirable in terms of processing that the item identification unit 41b narrow the comparison items to be compared with the target item down to one in this manner. However, the item identification unit 41b may identify, as reference items (an example of other items), related items that have not been identified as the comparison item. That is, in this case, the item identification unit 41b identifies, for each of one or more candidate users Un, a target item to be sold by the target seller SHm, a comparison item to be compared with the target item, and reference items except the target and comparison items, as an item set, among a plurality of items indicated by the candidate user Un's operation history. The transaction terms of the reference items thus identified are used to select change(s) to be described later.

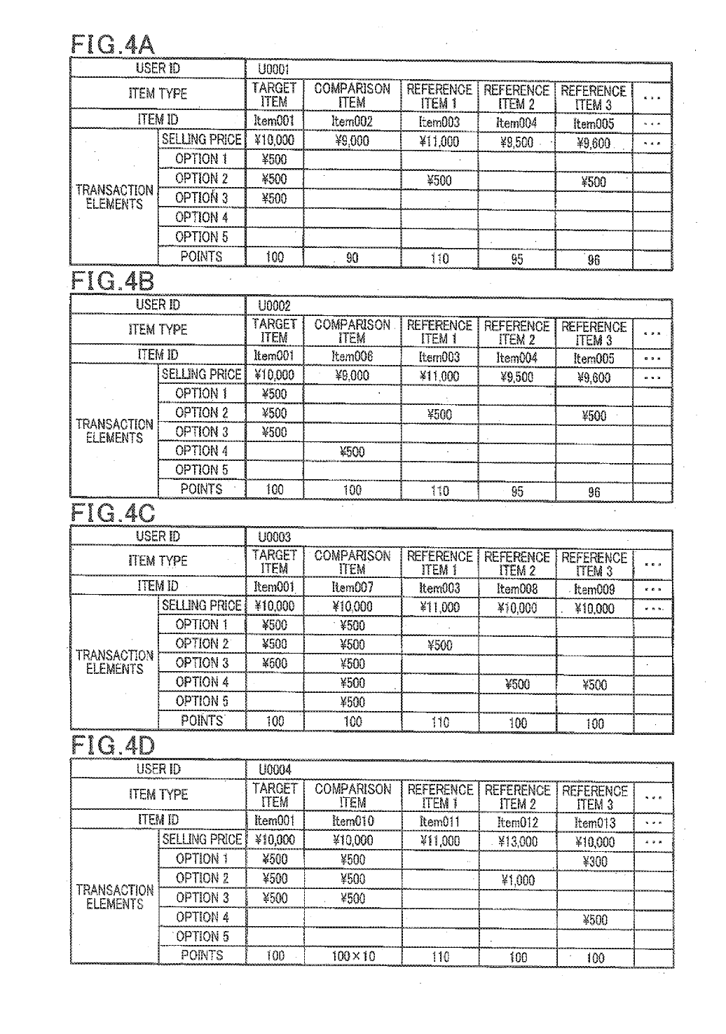

Subsequently, the terms changer 41c compares, for each candidate user Un (i.e., an item set for each candidate user Un), the transaction terms (i.e., the attribute values of transaction elements) of the above identified target item with the transaction terms (i.e., the attribute values of transaction elements) of the above identified comparison item. For example, the terms changer 41 compares the attribute values of each transaction element using a comparative table associating the transaction elements of the target item with the transaction elements of the comparison item. FIGS. 4A to 4D are each a diagram showing an example comparative table associating the attribute values of transaction elements of a target item with the attribute values of transaction elements of a comparison item. Each of the example tables of FIGS. 4A to 4D associates, for corresponding one of four users Un, the attribute values of the transaction elements of the target item, the attribute values of the transaction elements of the comparison item, and also the attribute values of the transaction elements of reference items with each other for comparison. In this embodiment, a sales promotion budget is associated with each item (each item ID) of one seller SHm. Thus, as shown in FIGS. 4A to 4D, the item ID of the target item for any user Un is the same (the item ID of the comparison item for any user Un is not necessarily the same, and the item ID of each reference item for any user Un is not necessarily the same). However, when a sales promotion budget is associated with all items of one seller SHm, the item ID of the target item for each user Un may be different.

If the transaction terms of the comparison item are more favorable than the transaction terms of the target item in each item set, the terms changer 41c changes the transaction terms of the target item so that they become more favorable than or comparable to the transaction terms of the comparison item. When making such changes, the terms changer 41c first selects, for each candidate user Un, one or more changes that make the transaction terms of the target item more favorable than or comparable to those of the comparison item, among the above plurality of types of changes (e.g., “option deletion”, “option addition”, “discount”, and “point increase”). Based on the selected change(s), the terms changer 41c changes, for each candidate user Un, the transaction terms of the target item so that they become more favorable than or comparable to the transaction terms of the comparison item.

The transaction terms of the comparison item are more favorable than the transaction terms of the target item, for example, (a) when the selling price of the comparison item (i.e., the attribute value of a selling price included in the transaction terms of the comparison item) is lower than the selling price of the target item, (b) when the selling price of the comparison item is the same as the selling price of the target item and the transaction terms of the comparison item include an option that the transaction terms of the target item do not include, and (c) when the selling price of the comparison item is the same as the selling price of the target item and the transaction terms of the comparison item include a larger number of points than the transaction terms of the target item. In some cases except the examples listed here, the transaction terms of the comparison item may be more favorable than the transaction terms of the target item. Data indicating cases where the transaction terms of the comparison item are more favorable than the transaction terms of the target item may be prestored, for example, in a table accessible to the terms changer 41c. In any of the above cases (a) to (c), at least one of the changes “option deletion (involving a discount)”, “option addition”, “discount”, and “point increase” corresponds to a change that can make the transaction terms of the target item more favorable than or comparable to those of the comparison item.

For example, (a) when the selling price of the comparison. item is lower than the selling price of the target item, the terms changer 41c selects a “discount” (a discount on the target item) that is greater than or equal to an amount corresponding to the difference between the selling price of the comparison item and the selling price of the target item as a change. For this change, in the example of FIG. 4A, the selling price “\10,000” of the target item “Item001” is changed to “\9,000” so that the selling price of the target item becomes comparable to the selling price of the comparison item “Item002” or is changed to “\8,500” so that the selling price of the target item becomes more favorable than the selling price of the comparison item “Item002”. Alternatively, in the case (a), if there are option(s) included in the transaction terms of the target item but not included in the transaction terms of the comparison item and the amount of the option(s) is greater than or equal to the amount corresponding to the above difference, the terms changer 41c may identify these option(s) as element(s) to be deleted and select “option deletion (involving a discount relative to the amount of the option(s))” for deleting the identified element(s) to be deleted as a change. This can reduce a financial resource burden imposed on the target seller SHm and facilitate the sale of the target item. For this change, in the example of FIG. 4A, two of the options 1 to 3 included in the transaction terms of the target item “Item001” are identified as elements to be deleted. The two options identified as elements to be deleted are then deleted from transaction terms of the target item “Item001”, and the total amount “\1,000” of the deleted options is subtracted from the selling price “\10,000” of the target item “Item001”. Consequently, the selling price “\10,000” of the target item “Item001” is changed so as to be comparable to the selling price “9,000” of the comparison item “Item002”. Preferably, in this case, based on option(s) included in the transaction terms of the reference items (only the reference items included in an item set for the same candidate user Un as the target item) identified by the item identification unit 41b, the terms changer 41c identifies an option except the option(s) as an element to be deleted. In this case, in the example of FIG. 4A, among the options 1 to 3 included, in the transaction terms of the target item “Item001”, the options 1 and 3, except the option 2, are identified as elements to be deleted the option is included in the transaction terms of the reference items 1 and 3. That is, the candidate user Un may possibly be caring about option(s) included in the transaction terms of the reference items, and thus such an option is preferentially kept in the transaction terms. This enables a transaction element that can satisfy the user's wishes to be kept.

In the example of FIG. 4B, the option 4 included in the transaction terms of the comparison item “Item006” is not included in the transaction terms of the target item “Item001”. In this case, assuming that the option 4 included in the transaction terms of the comparison item “Item006” appeals to the candidate user Un, it is preferable that the option 4 be included in the transaction terms of the target item “Item001” even when the selling price of the target item “Item001” becomes “\9,000” by subtracting the total amount “\1,000” of two elements to be deleted from the selling price “\10,000” of the target item “Item001”. For this reason, the terms changer 41c may select both “option deletion (involving a discount relative to the amount of option(s) for deleting option(s) included in the transaction terms of the target item and “option addition” for adding option(s) included in the transaction terms of the comparison item as changes. In the example of FIG. 4B, this deletes two options 1 and 3 identified as elements to be deleted from the transaction terms of the target item “Item001”. The selling price of the target item “Item001” then becomes “\9,000” by subtracting the total amount “\1,000” of the deleted options from the selling price “\10,000” of the target item “Item001”. In addition, the option 4 is added to the transaction terms of the target item “Item001”.

(b) When the selling price of the comparison item is the same as the selling price of the target item and the transaction terms of the comparison item include option(s) that the transaction terms of the target item do not include, the terms changer 41c identifies, as element(s) to be added, the option(s) included in the transaction terms of the comparison item but not included in the transaction terms of the target item, and selects “option addition” for adding the identified element(s) to be added as a change. This can facilitate the sale of the target item. For this change, in the example of FIG. 4C, among the options 1 to 5 included in the transaction terms of the comparison item “Item007”, the options 4 and 5 not included in the transaction terms of the target item “Item001” are identified as elements to be added, and the identified options 4 and 5 are added to the transaction terms of the target item “Item001”. Alternatively, in the case (b), the terms changer 41c may select both a “discount” (a discount on the target item) that exceeds the amount corresponding to the difference between the selling price of the comparison item and the selling price of the target item and “option addition” for adding opt or (included in the transaction terms of the comparison item as changes. For this change, in the example of FIG. 4C, the selling price “\10,000” is changed to “\9,500” so as to be more favorable than the selling price of the comparison item “Item007”, and one of the options 4 and 5 not included in the transaction terms of the target item “Item001” is identified as an element to be added, and the identified option is added to the transaction terms of the target item “Item001”. Preferably, in this case, based on option(s) included in the transaction terms of the reference items identified by the item identification unit 41b, the terms changer 41c identifies the option(s) as element(s) to be added. In this case, in the example of FIG. 4C, among the options 4 to 5 not included in the transaction terms of the target item “Item001”, the option 4 is identified as an element to be added because the option 4 is included in the transaction terms of the reference items 2 and 3. That is, the candidate user Un may possibly be caring about option(s) included in the transaction terms of the reference items, and thus such an option is preferentially kept in the transaction terms. This enables a transaction element that can satisfy the candidate user Un's wishes to be identified as an element to be added, and thus can facilitate the sale of the target item.

For example, (c) when the selling price of the comparison item is the same as the selling price of the target item and the transaction terms of the comparison item include a larger number of points than the transaction terms of the target item, the terms changer 41c selects “point increase” for adding points relative to the difference between the number of points included in the transaction terms of the comparison item and the number of points included in the transaction terms of the target item as a change. For this change, in the example of FIG. 4D, the number points “100” included in the transaction terms of the target item “Item001” is changed (i.e., increased to “1000”) so as to be comparable to the number of points “1000” included in the transaction terms of the comparison item “Item010”. Alternatively, in the case (c), the terms changer 41c may select a “discount” (a discount on the target item) that is less than or equal to, for example, the acceptable amount as a change. Also in the case (c), when the transaction terms of the comparison item further include an option not included in the transaction terms of the target item, the terms changer 410 may select “option addition” for adding the option included in the transaction terms of the comparison item but not included in the transaction terms of the target item as well as the “point increase” as changes, as described above.

If there are plurality of selectable changes, the terms changer 41c may select change(s) from among the plurality types of changes, based on the priorities that depend on the purpose of a seller SHm identified by the seller identification unit 41a. For example, the terms changer 41c retrieves, from the seller information database 21, the priorities for changes associated with the seller ID of a seller SHm identified by the seller identification unit 41a, and selects change(s) to which a relatively high priority is assigned among the retrieved priorities. In this case, one change (e.g., “option deletion”) with the highest priority may be selected. Alternatively, both a change (e.g., “option deletion”) with the highest priority and a change (e.g., “point increase”) with the second highest priority may be selected. The change(s) thus selected are applied to the item set of each candidate user Un. Alternatively, if there are a plurality of selectable changes, the terms changer 41c may select, for each of one or more candidate users Un, change(s) that contributed to purchases of items (items except the target item) by the candidate user Un, from among the plurality of types of changes, based on actual purchases indicated by the candidate user Un's purchase history. For example, when the purchase history associated with the user ID of the candidate user Un includes change(s) in the transaction terms of an item that resulted in purchase of the item in the past, the terms changer 41c selects the change(s) as change(s) that contributed to purchase of the item. This enables selection of change(s) that can satisfy the candidate user Un's wishes and that have a high sales promotion effect.

Preferably, in the change described above, the terms changer 41c changes, for each candidate user Un, the transaction terms of the target item so that the value corresponding to the difference between pre-change transaction terms and post-change transaction terms of the target item becomes less than or equal to the acceptable amount that is acceptable for change in the transaction terms of the target item (in other words, so that the value falls within a predetermined change range). When the change is “option deletion”, “the value corresponding to the difference” is an amount relative to the amount of option(s) to be deleted from the transaction terms of the target item (i.e., an amount subtracted from the selling price of the target item). When the change is “option addition”, “the value corresponding to the difference” is an amount relative to the amount of option(s) to be added to the transaction terms of the target item. When the change is “discount”, “the value corresponding to the difference” is an amount to be subtract from the selling price of the target item. When the change is “point increase”, “the value corresponding to the difference” is an amount relative to the number of points to be added to the number of points included in the transaction terms of the target item. When the changes are “option deletion” and “option addition”, “the value correspond in to the difference” is the sum of an amount relative to the amount of option(s) to be deleted to the transaction terms of the target item and an amount relative to the amount of option(s) to be added to the transaction terms of the target item. When the changes are “discount” and “option addition”, “the value corresponding to the difference” is the sum of an amount to be subtract from the selling price of the target item and an amount relative to the amount of option(s) to be added to the transaction terms of the target item. “So that the value corresponding to the difference becomes less than or equal to the acceptable amount” means that the transaction terms of the target item is changed by the value is fixed if the value is less than or equal to the acceptable amount, whereas the value is replaced with the acceptable amount (i.e., reduced to the acceptable amount) and then the transaction terms of the target item is changed by the value if the value exceeds the acceptable amount. If changing the transaction terms of the target item so that they are more favorable than or comparable to the transaction terms of the comparison item would cause the value corresponding to the difference to exceed the above acceptable amount, the change is not performed.

The above acceptable amount is retrieved, for example, using the item ID of the target item as a key from the item information database 23. Alternatively, the above acceptable amount may be determined based on the target seller SHm's sales situation (sales performance). In this case, the acceptable amount determiner 41d retrieves the sales amount or the sales quantity included in the actual sales associated with the item ID of the target item from the seller information database 21 and determines an acceptable amount based on the sales amount or the sales quantity. For example, the smaller the sales amount or the sales quantity, the larger the determined acceptable amount. That is, the more difficult a small sales amount or sales quantity makes the sales situation, the larger the acceptable amount becomes. This can facilitate the sale of the target item. Alternatively, the acceptable amount determiner 41d retrieves the stock quantity associated with the item ID of the target item from the seller information database 21. The more the stock quantity, the larger the acceptable amount determined by acceptable amount determiner 41d. That is, the more difficult the remaining stock makes the sales situation, the larger the acceptable amount becomes. This can facilitate the sale of the target item.

As another example, the above acceptable amount may be determined based on the number of users Un who are paying attention to the target item. In this case, the acceptable amount determiner 41d counts the number of users Un who are paying attention to the target item, based on the users Un's operation histories for the target item, and determines an acceptable amount (acceptable amount common to the candidate users Un, in this case) relative to the counted number of users Un paying attention. For example, the smaller the number of user Un paying attention, the larger the determined acceptable amount. This can also facilitate the sale of the target item. The number of users Un paying attention is, for example, the number of users Un who viewed the target item or the number of users who added the target item to their bookmark lists (or cart lists). Thus, the number of users Un paying attention can be calculated by counting the number of users Un whose viewing histories (alternatively, bookmark lists or cart lists) include the item ID of the target item.

Based on the conversion rate of items to be sold by the target seller SHm (e.g., 10%) and on the stock quantity of the target item (e.g., 10), the acceptable amount determiner 41d may calculate the number of people (100 people=stock quantity:10/conversion rate:0.1) required to sell out the remaining stock of the target item. The smaller number of users Un paying attention is less than the required number of people, the larger acceptable amount (acceptable amount common to the candidate users Un, also in this case) the acceptable amount determiner 41d may determine. For example, when the required number of people is 100 but the number of users Un paying attention is only 80, the unsold remainder of the target item is theoretically 2. To prevent such a thing, the smaller number of users Un paying attention is less than the required number of people, the larger the acceptable amount is made. This can reduce the unsold remainder of the target item. The conversion rate of items is, for example, the average value (alternatively, the standard deviation value or the median value) of the conversion rates of items that belong to the same item category as the target item, among a plurality of items to be sold by the target seller SHm. The conversion rates of items that belong to the same item category as the target item can be retrieved using an item ID associated with the seller ID of the target seller SHm as a key, from the total information database 25.

As still another example, the above acceptable amount may be determined based on each candidate user Un's purchase expectation (value quantitatively indicating how likely the target item is to be purchased). In this case, the acceptable amount determiner 41d determines, for each candidate user Un, the candidate user Un's purchase expectation for the target item, based on the candidate user Un's operation history, and determines an acceptable amount based on the determined purchase expectation. For example, the higher the purchase expectation, the larger the determined acceptable amount. This can also facilitate the sale of the target item.

The purchase expectation is determined based on the candidate user Un's item purchase interval. In this case, for example, the acceptable amount determiner 41d identifies an item purchase interval (e.g., the average value of purchase intervals) from the purchase history associated with the user ID of the candidate user Un. If the elapsed time between the latest purchase time and the current time is less than or equal to the above purchase interval (e.g., one week), the smaller the difference between the elapsed time and the purchase interval, the higher purchase expectation the acceptable amount determiner 41d determines. If the elapsed time between the latest purchase time and the current time exceeds the above purchase interval (e.g., one week), the acceptable amount determiner 41d adds an value relative to the elapsed time to the above determined purchase expectation to determine the purchase expectation (i.e., the longer the elapsed time, the more the purchase expectation increases). Alternatively, the purchase expectation may be determined based on the candidate user Un's purchase consideration level for the target item (an early stage or a late stage). In this case for example, from the viewing history associated with the user ID of the candidate user Un, the acceptable amount determiner 41d identifies a viewing status including at least either the viewing duration or the number of views for the target item, and also identifies an at-purchase actual viewing including at least either a viewing duration or the number of views (e.g., the average value of viewing durations or the numbers of views) before the user's past item purchases. If the viewing duration or the number of views included in the viewing status for the target item is less than the viewing duration or the number of views included in the at-purchase actual viewing, the acceptable amount determiner 41d determines a first purchase expectation (a relatively low value) because the purchase consideration level is an early stage”. On the other hand, if the viewing duration or the number of views included in the viewing status for the target item is greater than or equal to the viewing duration or the number of views included in the at-purchase actual viewing, the acceptable amount determiner 41d determines a second purchase expectation that is higher than the first purchase expectation because the purchase consideration level is a late stage.

Alternatively, the purchase expectation may be determined based on the elapsed time from the viewing start time (or search start time) at which the candidate user Un started to view (or search for) the target item. In this case, for example, the acceptable amount determiner 41d identifies the viewing start time (or search start time) for the target item from the viewing history (or search history) associated with the user ID of the candidate user Un. This viewing start time (search start time) is the time at which the candidate user Un viewed (searched for) the target item for the first time. The shorter the elapsed time between the above viewing start time (or search start time) and the current time, the higher purchase expectation the acceptable amount determiner 41d determines. That is, the purchase expectation is higher when a target product was viewed a month ago than when it was viewed a week ago. Alternatively, the purchase expectation may be determined based on how the candidate user Un reacts to a change in the transaction terms of the target item (a low reaction or a high reaction). In this case, for example, from the purchase history associated with the user ID of the candidate user Un, the acceptable amount determiner 41d identifies the same change (change in the transaction terms of an item that resulted in purchase of the item in the past) as the above determined change and the change time, and also identifies the purchase time of the item. The shorter the elapsed time between the change time and the purchase time, the higher purchase expectation the acceptable amount determiner 41d determines. That is, the shorter the elapsed time between the change time and the purchase time, the higher the reaction produced by the candidate user Un. Thus, the purchase expectation is set to be higher.

Subsequently, from among the candidate users Un corresponding one-to-one to the target items whose transaction terms have been changed, with priority given to candidate users Un for which a value corresponding to the difference between pre-change transaction terms and post-change transaction terms of the target item is relatively small to be targets, the target user determiner 41e determines a plurality of target users Un to be notified of the post-change transaction terms, so as to satisfy the target seller SHm's seller requirements. Each target seller SHm's seller requirements are requirements specified for the corresponding seller SHm and, for example, may be stored in association with the seller ID of the seller SHm in the seller information database 21. The target seller SHm's seller requirements include, for example, a requirement indicating that the total sum of values corresponding to the differences between pre-change transaction terms and post-change transaction terms of the target items falls within the target seller SHm's sales promotion budget.

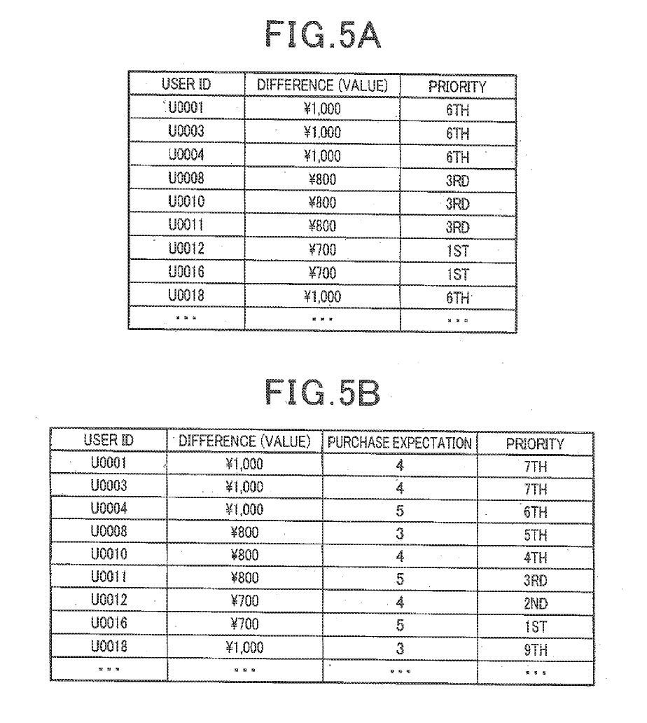

FIG. 5A is a diagram showing, for each candidate user Un, an example relationship between a value corresponding to the difference between pre-change transaction terms and post-change transaction terms of a target item and a priority for determining the candidate user Un to be a target user Un. The target user determiner 41e determines candidate users Un to be target users Un in order of increasing values corresponding to the above differences (in order of ascending priorities from first, as shown in FIG. 5A) and finishes the determination when the total sum of the values reaches the target seller SHm's sales promotion budget. Alternatively, the target seller SHm's seller requirements include, for example, a requirement indicating that the total sum of values corresponding to the differences between pre-change transaction terms and post-change transaction terms of the target items falls within the target seller SHm's sales promotion budget and a requirement indicating that a predetermined number of candidate users Un are identified. In this case, the target user determiner 41e divides the sales promotion budget by the predetermined number to determine a budget per user and determines the predetermined number of candidate users Un for which a value corresponding to the above difference is less than or equal to the budget to be target users Un. Preferably, the predetermined number is determined so as to be the number of people required to sell out the remaining stock of the target item. As described above, this required number of people is calculated based on the conversion rate of items to be sold by the target seller SHm and on the stock quantity of the target item. The above predetermined number may be freely specified by the target seller SHm.

Preferably with priority given to candidate users Un for which the value co responding to the difference between pre-change transaction terms and post-change transaction terms of the target item is relatively small and whose purchase expectation for the target item is relatively high, the target user determiner 41e determines the predetermined number of target users Un so that the total sum of the values falls within the target seller SHm's sales promotion budget. This makes it possible to determine candidate users Un on which a change with less burden on the seller can produce a relatively high sales promotion effect to be notified of the post-change transaction terms of the target item. FIG. 5B is a diagram showing, for each candidate user Un, an example relationship among a value corresponding to the difference between pre-change transaction terms and post-change transaction terms of a target item, an purchase expectation of the candidate user Un, and a priority for determining the candidate user Un to be a target user Un. As shown in FIG. 5B, for example, when there are a plurality of candidate users Un for which the values corresponding to the above differences are the same, the target user determiner 41e preferentially (at high priority) determines candidate users Un whose purchase expectation determined as described above is high to be target users Un.

Subsequently, the target user notifier 41f notifies each of the target users Un determined by the target user determiner 41e of notification information including the post-change transaction terms and the name of the target item that correspond to the target user Un. The notification information includes at least either text data or image data. For example, the target user notifier 41f sends an email containing the above notification information written in its body to the email address associated with the user ID of each target user Un to notify the target user Un of the notification information. Alternatively, the target user notifier 41f sends the above notification information to the user terminal UTn (user terminal UTn maintaining a session) of each target user Un to notify the target user Un of the notification information. In this case, for example, the target user notifier 41f sends the above notification information to the user terminal UTn maintaining a session to cause the user terminal. UTn to display the notification information on a toolbar that is a plug-in of the web browser. Alternatively, the target user notifier 41f sends the above notification information to the user terminal UTn maintaining a session to cause the user terminal UTn to display the notification information on a web page being displayed in a window of the web browser. Alternatively, the target user notifier 41f sends a web page that shows the above notification information to the user terminal UTn maintaining a session to cause the user terminal UTn to display the web page in a window of the web browser.

### 2. How Information Providing System S Works

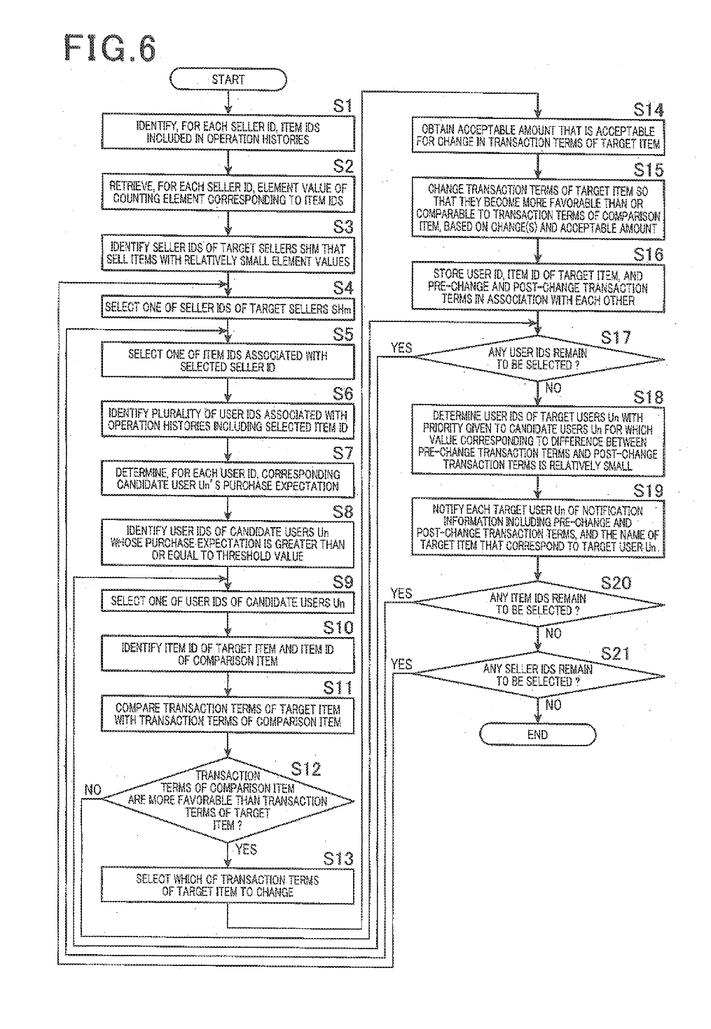

The following describes how the information providing system S according to this embodiment works with reference to FIG. 6. FIG. 6 is a flowchart showing an example of an information provision process performed by the, system controller 4 of the information providing server SA. The information provision process shown in FIG. 6 is performed, for example, at predetermined intervals.

When the information provision process shown in FIG. 6 is started, the system controller 4 (seller identification unit 41a) identifies the seller IDs of a plurality of sellers SHm from the seller information database 21, identifies, for each seller ID, the item IDs associated with the identified seller ID from the item information database 23, and identifies, for each seller ID, item IDs that are among the item IDs identified for the seller ID and included in the operation histories stored in the user information database 22 (Step S1). The system controller 4 may identify, for each seller ID identified from the seller information database 21, the item IDs associated with the seller ID from item information database 23, and identify, for each seller ID, the item IDs of items registered for future reference by the users Un, among the item IDs identified for the seller ID, from the reference information database 24.

Subsequently, the system controller 4 (seller identification unit 41a) retrieves, for each seller ID, the element value of a counting element associated with the item IDs identified in Step S1 from the total information database 25 (Step S2). As described above, when the element values of a counting element of a plurality of items are stored for one seller ID in the total information database 25, for example, the average value (alternatively, the standard deviation value or the median value) of the element values of the counting element of the plurality of items is obtained as the element value of the counting element.

Next, the system controller 4 (seller identification unit 41a) identifies, as the seller IDs of target sellers SHm, the seller IDs associated with item IDs corresponding to relatively small element values (e.g., the item IDs items that were viewed a small number of times), among the element values retrieved for the seller IDs in Step S2 (Step S3). Preferably, the system controller 4 (seller identification unit 41a) totals, for each item category, the element values retrieved for the seller IDs to calculate, for the item category, a representative element value (the average value, standard deviation value, or median value of element values) as all of the plurality of sellers SHm, and identifies, as the seller IDs of target sellers SHm, the seller IDs associated with the item IDs corresponding to element values less than the representative element value of a specific item category (e.g., an item category set by the system administrator or the like). Alternatively, the system controller 4 (seller identification unit 41a) may total, for each item category, the element values retrieved for the seller IDs to calculate, for the item category, a representative element value (the total value of element values) as all of the plurality of sellers SHm, and identify, as the seller IDs of target sellers SHm, the seller IDs associated with the item IDs correspond to element values whose percentage to the representative element value of a specific item category is relatively small. The system controller 4 (seller identification unit 41a) may identify, as the seller IDs of target sellers SHm, the seller IDs of sellers SHm that have more than a predetermined amount of sales promotion budget for an item and have not yet reached their sales target for the item, by referring to the seller information database 21.

After that, the system controller 4 selects one of the seller IDs (the seller IDs of the target sellers SHm) identified in Step 53 (Step S4). The system controller 4 then selects one of the item IDs associated with the seller ID selected in Step S4 (Step S5). The item ID selected in this step is the item ID of the above target item.

Subsequently, the system controller 4 identifies a plurality of user IDs associated with operation histories including the item ID selected in Step S5 (Step S6). The user IDs identified in this step is the user IDs of candidate users Un. Next, the system controller 4 determines, for each user Un (user ID), a purchase expectation of the candidate user Un corresponding to each of the user IDs identified in Step S6 (Step S7). The candidate user Un's purchase expectation is determined based on how often the candidate user Un purchases items, at what level the candidate user Un considers purchasing the target item, how much time has elapsed since the time at which the candidate user Un started to view the target item, or how the candidate user Un reacts to a change in the transaction terms of the target item.

After that, the system controller 4 identifies the user IDs of candidate users Un whose purchase expectation determined in Step S7 is greater than or equal to a threshold value (Step S8). Thus, many candidate users Un can be narrowed down to candidate users Un who are expected to purchase the target item. If the number of the user IDs determined in Step S6 is less than a predetermined number, Steps S7 and S8 may be skipped and the process may proceed to Step 9. Subsequently, the system controller 4 selects one of the user IDs (the user IDs of the candidate users Un) identified in Step S8 (or Step S6) (Step S9).

Next, the system controller 4 (item identification unit 41b) identifies the item ID (the item ID of the target item) associated with the seller ID (the seller ID of the target seller SHm) selected in Step S4 and the item ID (the item ID of a comparison item) associated with another seller ID than the seller ID of the target seller SHm, among a plurality of item IDs indicated by the operation history of the candidate user in selected in Step S9 (Step S10).

After that, the system controller 4 (terms changer 41c) compares the transaction terms associated with the item ID of the target item (the transaction terms of the target item), identified in Step S10, with the transaction terms associated with the item ID of the comparison item (the transaction terms of the comparison item), identified in Step S10 (Step S11). For example, this can provide, for each transaction element (“selling price”, “option”, “points”), the value obtained by subtracting the element value of the transaction element of the comparison item from the element value of the transaction element of the target item as the result of the comparison. Subsequently, based on the result of the comparison in Step S11, the system controller 4 (terms changer 41c) determines whether the transaction terms of the comparison item are more favorable than the transaction terms of the target item (Step S12). For example, it is determined r each transaction element whether the value obtained as the result of the comparison in Step S11 is a positive value, zero, or a negative value. For example, if the value obtained as the result of the comparison of the selling prices to be determined is a positive value, it is determined that the transaction terms of the comparison item are more favorable than the transaction terms of the target item. If the value obtained as the result of the comparison of the selling prices to be determined is zero and the value obtained as the result of the comparison of the options to be determined is a negative value, it is determined that the transaction terms of the comparison item are more favorable than the transaction terms of the target item. If the value obtained as the result of the comparison of the selling prices to be determined is zero and the value obtained as the result of the comparison of the points to be determined is a negative value, it is determined that the transaction terms of the comparison item are more favorable than the transaction terms of the target item. If the value obtained as the result of the comparison of the selling prices to be determined is zero, the value obtained as the result of the comparison of the options to be determined is zero, and the value obtained as the result of the comparison of the points to be determined is a negative value, it is determined that the transaction terms of the comparison item are more favorable than the transaction terms of the target item. Steps S11 and S12 are separated in the above example, but Steps S11 and S12 may be combined. If it determines that the transaction terms of the comparison item are more favorable than the transaction terms of target item (YES in Step S12), the system controller 4 (terms changer 41c) causes the process to proceed to Step S13. On the other hand, if it determines that the transaction terms of the comparison item are less favorable than the transaction terms of target item (NO in Step S12), the system controller 4 (terms changer 41c) causes the process to proceed to Step S17.

In Step S13, the system controller 4 (terms changer 41c) selects which of the transaction terms of the target item to change. In this step, as described above, one or more changes are selected based on how the transaction terms of the comparison item are more favorable than the transaction terms of the target item. As described above, if there are plurality of selectable changes, the change(s) may be selected based on the priorities that depend on the target seller SHm's purpose, the candidate users Un's actual purchases, or changes that contributed to purchases of items by the candidate user Un. Next, the system controller 4 (terms changer 41c) obtains an acceptable amount that is acceptable for change in the transaction terms of the target item (Step S14). As described above, the acceptable amount to be obtained is determined based on the target seller SHm's sales situation, the number of users Un who are paying attention to the target item, or each candidate user Un's purchase expectation. Alternatively, the acceptable amount may be retrieved using the item ID of the target item as a key from the item information database 23.

After that, the system controller 4 (terms changer 41c) changes the transaction terms of the target item so that they become more favorable than or comparable to the transaction terms of the comparison item, based on the change(s) selected in Step S13 and the acceptable amount obtained in Step S14 (Step S15). In this step, the system controller 4 (terms changer 41c) changes the transaction terms of the target item so that a value corresponding to the difference between pre-change transaction terms and post-change transaction terms of the target item becomes less than or equal to the acceptable amount obtained in Step S13. The initial value of the acceptable amount may be set to an acceptable amount retrieved using the item ID of the target item as a key from the item information database 23. In this case, only when the value corresponding to the above difference exceeds the acceptable amount, set as the initial value, an acceptable amount determined based on the target seller SHm's sales situation, the number of users Un who are paying attention to the target item, or each candidate user Un's purchase expectation is newly set. The system controller 4 (terms changer 41c) then changes the transaction terms of the target item so that the value corresponding to the difference between pre-change transaction terms and post-change transaction terms of the target item becomes less than or equal to the newly set acceptable amount.

Subsequently, the system controller 4 (terms changer 41c) stores the user ID (the user ID of a candidate user Un) selected in Step S9, the item ID of the target item whose transaction terms have been changed in Step S15, the pre-change transaction terms, and the post-change transaction terms in association with each other in a predetermined area of the RAM (Step S16), and causes the process to proceed to Step S17. If changing the transaction terms of the target item so that they are more favorable than or comparable to the transaction terms of the comparison item causes the value corresponding to the difference to exceed the above acceptable amount, Steps S15 and S16 are skipped and the process proceeds to Step S17.

In Step S17, the system controller 4 determines whether any of the user IDs identified in Step S8 (or S6) remain to be selected. If it determines that some of the user IDs remain to be selected (YES in Step S17), the system controller 4 causes the process to return to Step S9. The system controller 4 selects one of the user IDs yet to be selected, and then performs Step S10 and subsequent steps. On the other hand, if it determines that none of the user IDs remain to be selected (NO in Step S17), the system controller 4 causes the process to proceed to Step S18.

In Step S18, from among the candidate users Un identified by the user IDs stored in Step S16 (the candidate users Un corresponding to the target item whose transaction terms have been changed), the system c controller 4 (target user determiner 41e) determines the user IDs of a plurality of target users Un so as to satisfy the target seller SHm'seller requirements, with priority given to candidate users Un for which the value corresponding to the difference between the pre-change transaction terms and the post-change transaction terms stored in Step S16 is relatively small. This determining step is as described above. However, in Step S18, the system controller 4 (target user determiner 41e) may determine the user IDs of a plurality of target users Un so as to satisfy the target seller SHm's seller requirements, with priority given to candidate users Un for which the value corresponding to the difference between the pre-change transaction terms and the post-change transaction terms of the target item is relatively small and whose purchase expectation for the target item is relatively high.

Subsequently, the system controller 4 (target user notifier 41f) notifies the target user Un identified by each of the user IDs determined in Step S18 of notification information including The pre-change and post-change transaction terms, and the name of the target item that correspond to the target user Un (Step S19).

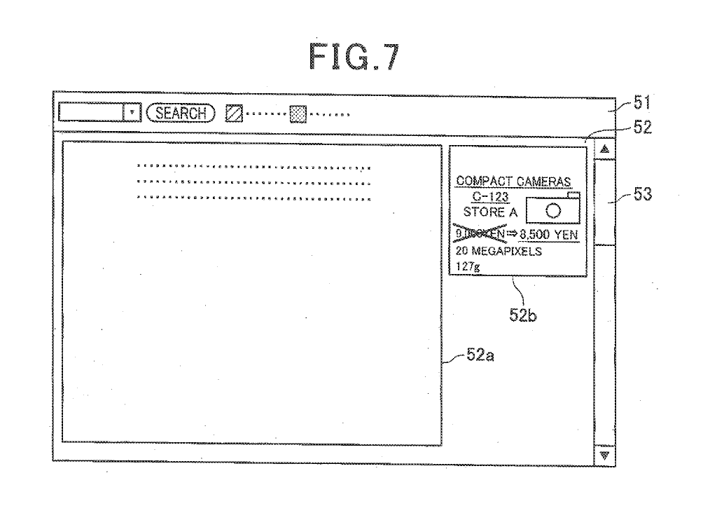

FIG. 7 is a diagram showing an example screen displaying notification information on a web page being displayed in a window of a web browser of a user terminal UTn maintaining a session. On the screen shown in FIG. 7, a toolbar 51 and a window 52 are provided. A web page is being displayed in the window 52. This web page includes a content display area 52a and an advertisement display area 52b. The web page is designed to scroll on the window 52 in response to the move of a scroll bar 53 when a user Un performs a scrolling operation. What content is displayed in the content display area 52a depends on the type of the web page. For example, blog posts, item search results, or news articles are displayed in the content display area 52a. Notification information is being displayed in the advertisement display area 52b. This notification information includes the name of a target item and its pre-change selling price and post-change selling price. The advertisement display area 52b includes an item link to an item details display page for the target item. The notification information may be sent to the user terminal UTn maintaining the session to be displayed on the toolbar 51 that is a plug-in of the web browser.

Next, the system controller 4 determines whether any of the item IDs associated with the seller ID selected in Step S4 remain to be selected (Step S20). If it determines that some of the item IDs remain to be selected (YES in Step S20), the system controller 4 causes the process to return to Step S5. The system controller 4 selects one of the item IDs yet to be selected, and then performs Step S6 and subsequent steps. On the other hand, if it determines that none of the user TDs remain to be selected (NO in Step S20), the system controller 4 causes the process to proceed to Step S21.

In Step S21, the system controller 4 determines whether any of the seller IDs identified in Step S3 remain to be selected. If it determines that some of the seller IDs remain to be selected (YES in Step S21), the system controller 4 causes the process to return to Step S4. The system controller 4 selects one of the seller IDs yet to be selected, and then performs Step S5 and subsequent steps. On the other hand, if it determines that none of the seller IDs remain to be selected (NO in Step S21), the system controller 4 terminates the process.

As described above, according to the above embodiment, the system controller 4 identifies, for each candidate user Un, a target item to be sold by a target seller SHm and a comparison item to be sold by another seller SHm than the target seller SHm, from among a plurality of items indicated by the candidate user Un's operation history for items to be sold by the target seller SHm. The system controller 4 then compares, for each candidate user Un, transaction terms between the above identified target and comparison items. If the transaction terms of the comparison item are more favorable than the transaction terms of the target item, the system controller 4 changes the transaction terms of the target item so that they become more favorable than or comparable to the transaction terms of the comparison item. From among the candidate users Un corresponding one-to-one to the target items whose transaction terms have been changed, the system controller 4 determines, with priority given to candidate users Un for which a value corresponding to the difference between pre-change transaction terms and post-change transaction terms of the target item is relatively small, a plurality of target users Un to be notified of the post-change transaction terms, so as to satisfy the target seller SHm's seller requirements. This makes it possible to determine candidate users tin on which a change with less burden on the target seller SHm can produce a relatively high sales promotion effect to be notified of the post-change transaction terms of the target item.

### REFERENCE SIGNS LIST

1 communication unit

2 storage unit

3 input/output interface unit

4 system controller

STm seller terminal

UTn user terminal

SA information providing server

1. An information processing device which is accessed by a plurality of user terminals through a network, and is accessable to a database for storing, for each user, the user's operation history for items in correspondence with user ID, comprising:
at least one memory configured to store computer program code;
at least one processor configured to access said at least one memory and operate according to said computer program code, said computer program code including:
item identifying code configured to cause at least one of said at least one processor to identify, for each user, a target item to be provided by a specific seller and a comparison item to be sold by another seller than the specific seller and to be compared with the target item, among a plurality of items indicated by the user's operation history, from the database;
terms changing code configured to cause at least one of said at least one processor to compare, for each of the users, transaction terms of the target item with transaction terms of the comparison item, and change, for each of the users, the transaction terms of the target item so that the transaction terms of the target item become more favorable than or comparable to the transaction terms of the comparison item if the transaction terms of the comparison item are more favorable than the transaction terms of the target item;
user determination code configured to cause at least one of said at least one processor to determine, with priority given to users for which a value corresponding to a difference between the transaction terms of the target item before change and the transaction terms of the target item after change is relatively small, a plurality of users to be notified of the transaction terms after the change, so as to satisfy the specific seller's seller requirements, from among the users corresponding one-to-one to the target items whose transaction terms have been changed; and
notifying code configured to cause at least one of said at least one processor to notify each user determined as a user to be notified, of notification information including the transaction terms before change and the transaction terms after change corresponding to each user, through the user terminal of each user.

2. The information processing device according to claim 1, wherein
the user determination code is configured to cause at least one of said at least one processor to determine, with priority given to users for which the value is relatively small and whose purchase expectation for the target item is relatively high, a plurality of users to be notified of the transaction terms after the change, so as to satisfy the specific seller's seller requirements.

3. The information processing device according to claim 1, further comprising
acceptable amount determination code configured to cause at least one of said at least one processor to count the number of users paying attention to the target item, based on users' operation histories for the target item, and determine an acceptable amount relative to the number of users paying attention, the acceptable amount being acceptable for change in the transaction terms of the target item, wherein
the terms changing code is configured to cause at least one of said at least one processor to change, for each of the users, the transaction terms of the target item so that the value corresponding to the difference between the transaction terms of the target item before change and the transaction terms of the target item after change becomes less than or equal to the acceptable amount determined.

4. The information processing device according to claim 3, wherein
the acceptable amount determination code is configured to cause at least one of said at least one processor to calculate the number of people required to sell out remaining stock of the target item, based on a conversion rate of items to be provided by the specific seller and on a stock quantity of the target item, and
the smaller number of users paying attention is less than the required number of people, the larger acceptable amount the acceptable amount determination code determines.

5. The information processing device according to claim 1, further comprising
acceptable amount determination code configured to cause at least one of said at least one processor to determine an acceptable amount based on a corresponding user's purchase expectation for the target item, the acceptable amount being acceptable for change in the transaction terms of the target item, wherein
the terms changing code is configured to cause at least one of said at least one processor to change, for each of the users, the transaction terms of the target item so that the value corresponding to the difference between the transaction terms of the target item before change and the transaction terms of the target item after change becomes less than or equal to the acceptable amount determined by the acceptable amount determination code.

6. The information processing device according to claim 1, wherein
the terms changing code is configured to cause at least one of said at least one processor to select, for each of one or more of the users, a change that contributed to purchases of items by the user, from among a plurality of types of changes, based on actual purchases indicated by the user's purchase history, and changes the transaction terms of the target item, based on the determined change.

7. The information processing device according to claim 1, wherein
the terms changing code is configured to cause at least one of said at least one processor to identify, for each of one or more of the users, a transaction element included in the transaction terms of the target item but not included in the transaction terms of the comparison item as a target element, determine a change to delete the identified target element, and change the transaction terms of the target item, based on the determined change.

8. The information processing device according to claim 1, wherein
the terms changing code is configured to cause at least one of said at least one processor to identify, for each of one or more of the users, a transaction element included in the transaction terms of the comparison item but not included in the transaction terms of the target item as a target element, determine a change to add the identified target element, and change the transaction terms of the target item, based on the determined change.

9. The information processing device according to claim 7, wherein
the item identifying code is configured to cause at least one of said at least one processor to identify, for each of one or more of the users, a target item to be provided by a specific seller, a comparison item to be sold by another seller than the specific seller and to be compared with the target item, and other items except the target and comparison items, among a plurality of items indicated by the user's operation history, and
the terms changing code is configured to cause at least one of said at least one processor to identify the target element, based on transaction elements included in transaction terms of the other items.

10. An information processing method performed by a server which is accessed by a plurality of user terminals through a network, and is accessible to a database for storing, for each user, the user's operation history for items in correspondence with user ID, the method comprising:
identifying, for each user, a target item to be provided by a specific seller and a comparison item to be sold by another seller than the specific seller and to be compared with the target item, among a plurality of items indicated by the user's operation history, from the database;
comparing, for each of the users, transaction terms of the target item with transaction terms of the comparison item;
changing, for each of the users, the transaction terms of the target item so that the transaction terms of the target item become more favorable than or comparable to the transaction terms of the comparison item if the transaction terms of the comparison item are more favorable than the transaction terms of the target item;
determining, with priority given to users for which a value corresponding to a difference between the transaction terms of the target item before change and the transaction terms of the target item after change is relatively small, a plurality of users to be notified of the transaction terms after the change, so as to satisfy the specific seller's seller requirements, from among the users corresponding one-to-one to the target items whose transaction terms have been changed; and
notifying each user determined as a user to be notified by the determining, of notification information including the transaction terms before change and the transaction terms after change corresponding to each user, through the user terminal of each user.

11. A non-transitory recording medium recording an information processing program for causing a computer which is accessed by a plurality of user terminals through a network, and is accessible to a database for storing, for each user, the user's operation history for items in correspondence with user ID, to:
identify, for each user, a target item to be provided by a specific seller and a comparison item to be sold by another seller than the specific seller and to be compared with the target item, among a plurality of items indicated by the user's operation history, from the database;
compare, for each of the users, transaction terms of the target item with transaction terms of the comparison item, and for changing, for each of the users, the transaction terms of the target item so that the transaction terms of the target item become more favorable than or comparable to the transaction terms of the comparison item if the transaction terms of the comparison item are more favorable than the transaction terms of the target item;
determine, with priority given to users for which a value corresponding to a difference between the transaction terms of the target item before change and the transaction terms of the target item after change is relatively small, a plurality of users to be notified of the transaction terms after the change, so as to satisfy the specific seller's seller requirements, from among the users corresponding one-to-one to the target items whose transaction terms have been changed, and
notify each user determined as a user to be notified, of notification information including the transaction terms before change and the transaction terms after change corresponding to each user, through the user terminal of each user.
